(19) United States
(12) Patent Application Publication
(10) Pub. No.: US 2020/0092683 A1
(43) Pub. Date: Mar. 19, 2020

(54) STICKER LOCATION DEVICE AND ASSOCIATED METHODS

(71) Applicant: 4IIII INNOVATIONS INC, Cochrane (CA)

(72) Inventors: Kipling William FYFE, Cochrane (CA); Billy Cheuk Wai CHAN, Calgary (CA); Ken FYFE, Cochrane (CA)

(21) Appl. No.: 16/610,353

(22) PCT Filed: Apr. 30, 2018
(86) PCT No.: PCT/IB2018/052969

§ 371 Date: Nov. 1, 2019

Related U.S. Application Data
(60) Provisional application No. 62/492,565, filed on May 1, 2017.

(51) Int. Cl. H04W 4/029; H04L 29/06; H04L 29/08

(52) U.S. Cl. CPC H04W 4/029; G01B 21/32; H04L 67/125; H04L 69/18

(57) ABSTRACT

A “sticker” location device includes a PCB with a processor and memory, a communicator for communicating with other location devices and a server, one or more sensors for determining an environment of the location device, and a power module. Some embodiments include GPS receivers and may serve as digital radio network hubs or bridges for other location devices. A method for tracking the location of assets uses these location devices attached to assets to sense an environment of the assets by comparing sensed environment to previously sensed environment, and communicating the changes in the environment from the location device to a server when the changes exceed a configurable threshold. Some embodiments include determining location with GPS and/or relaying signals from other location devices, and smart power management using low power digital radio modes unless sufficient energy is available for high power modes.

### CLAIM TO PRIORITY

The present document claims priority to U.S. Provisional Patent Application 62/492,565 filed 1 May 2017.

### BACKGROUND

Tracking devices, such as Tile, TrackR, Chipolo and Wuvo are small battery powered electronic devices that are attached to an object to be tracked, and interface wirelessly to connect with a smartphone such as an iPhone or Android phone. However, these existing tracking devices are not position aware, and have only a short-range transmission capability. A specific brand of tracking device is detected only by a corresponding app running on the smartphone.

### SUMMARY

An intelligent tracking unit includes location determination and communication capability, and is herein called a “sticker.” The sticker is attached to, or embedded in, an object to be tracked, such as an asset of value, of importance, or of interest.

The sticker tracking device determines and communicate its approximate or exact location through one or more wireless digital radio and/or wired networks. The sticker may use information gathered from these one or more wireless and/or wired networks to help determine its location. If the sticker is sensed by a cellphone, the cellphone's location can also be added to the sticker's location history, The sticker tracking device may determine when it is lost and initiate communications to make its current location known to a wider network. The sticker may be self-powered or powered by a wired. connection. The sticker may be installed on or embedded into assets during manufacturing or be installed on or embedded in the asset after manufacture. The sticker contains sensors it uses to determine information about its movement and environment to aid in location of the sticker, and thus location of the corresponding asset. In certain embodiments, the sticker also maintains a history of movement, environment, and/or determined locations to aid in determining why the asset was moved. This history may be stored in a database either locally on the sticker device or it may be passed to a network when a connection is possible.

A sticker location device includes a circuit board within a housing having a processor and memory, a communicator for communicating with other sticker location devices and a server, an awareness module having at least one sensor for determining a location of the sticker device, and a power module. Some embodiments include UPS receivers and may serve as network hubs or bridges for other devices and sticker location devices. A method for tracking the location of assets uses the sticker location devices attached to assets to sense an environment (such as temperature, pressure, light, sound, etc.) of the asset by comparing sensed environment to previously sensed environment, and reporting the changes in the environment from the sticker location device to a server or other report-receiving device when the changes exceed a configurable threshold. Some embodiments include determining location with GPS and/or relaying signals from other sticker location devices, and smart power management using low power digital radio modes unless sufficient energy is available for high power modes.

### BRIEF DESCRIPTION OF THE FIGURES

FIG. 1 is a high-level block diagram illustrating one exemplary sticker location device communicating with a server, in an embodiment.

FIG. 2 shows the sticker location device of FIG. 1 implemented as a thin, flexible housing containing electronics that may be attached to an asset, in an embodiment.

FIG. 3 shows the sticker location device of FIG. 1 in further exemplary detail.

FIG. 4 shows communication capability of the sticker location device of FIGS. 1 and 3 in further exemplary detail.

FIG. 5 shows the server of FIG. 1 in further exemplary detail.

FIG. 6 shows one example scenario where the sticker location device of FIG. 1 increases the range of an existing tracking device.

FIG. 7 shows one exemplary herd of four sticker location devices of FIG. 1 that maintains herd awareness, in an embodiment.

FIG. 8 shows one exemplary scenario where the sticker location device of

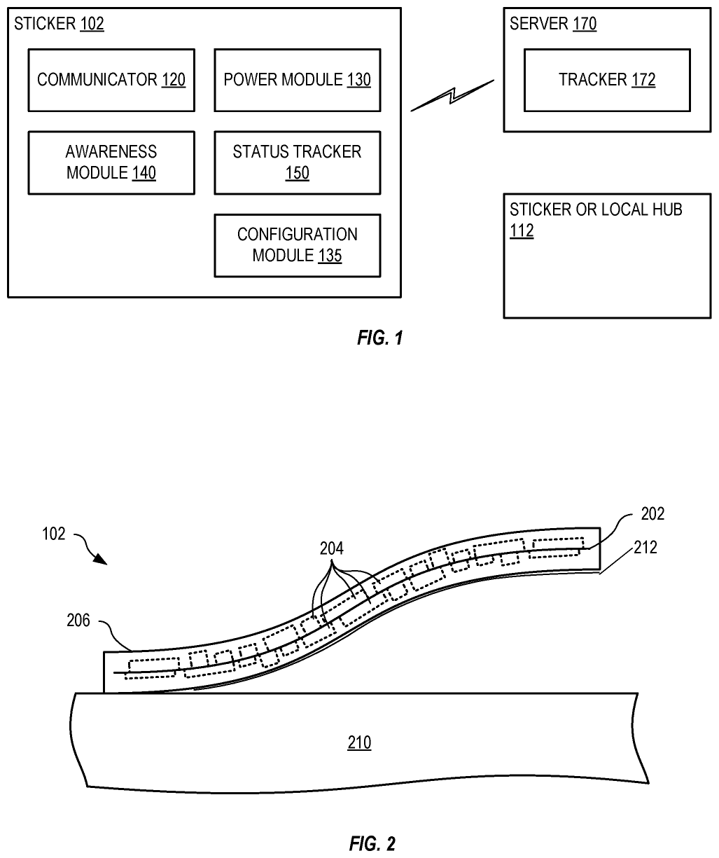

FIG. 1 operates in a state awareness mode, in an embodiment.

FIG. 9 is a flowchart illustrating actions taken by an embodiment of the sticker location device.

### DETAILED DESCRIPTION OF THE EMBODIMENTS

### Issues with Certain Prior Tracking Devices

To keep certain prior tracking devices small, location was determined within a smartphone each time a periodic transmission from the tracking device is received by the smartphone. When an expected communication is not received, the last determined location indicates a “likely” location of the tracking device and assumes that the tracking device has not moved. The transmission from these prior tracking devices was short-range (e.g., Bluetooth) to conserve power and such that the location determined within the smartphone is near the tracking device's actual location.

Although these prior tracking devices may he detected and located by any smartphone running the corresponding app, locating a lost tracking device, such as when not found at the last previously determined location, requires at least one such smartphone be near enough to the tracking device to receive periodic transmissions from it. Where a smartphone is not close enough to receive the short-range transmission from the tracking device, these prior tracking devices remain “lost”. These particular prior tracking devices do not determine their location themselves and are not smart enough to determine when they are moved or become lost—requiring a search with a corresponding seeking device to detect when they are, or are not, proximate.

Since these prior tracking devices only transmit periodically, their location can only be estimated by the detecting device at the time of transmission. When the tracking device is moved, it is not tracked or determined as lost until the next expected transmission from the tracking device is missed. Further, these prior tracking devices transmit only on a predetermined schedule and cannot provide additional transmissions upon disturbance or movement of the tracking device.

### Our New Sticker Tracking Device

A new, self-aware, sticker location device (hereinafter a “sticker”) provides a tracking solution itself, and also extends range and usefulness of existing tracking devices. The sticker is configured to act as partner with many different kinds of existing tracking devices, and to relay information of existing tracking devices to a partner of the existing tracking device via any available compatible network(s).

By including such functionality into the sticker, the entire asset tracking network becomes more useful, since existing tracking devices, as well the new stickers, can now communicate location information to a corresponding partner device via any available compatible network, including digital radio networks. That is, the new design sticker may operate as a relay device for both (a) existing tracking devices, thereby allowing the existing tracking device to use other networks, and (b) other new stickers. The sticker provides enhanced location functionality and improves usefulness of existing tracking devices by providing additional ways to detect and locate the existing tracking devices.

FIG. 1 is a high-level block diagram illustrating one exemplary sticker location device 102. that communicates with a report receiving device such as server 170 or a mobile device 802 (FIG, 8). In alternative embodiments, the report receiving device may be another sticker 112 or other local hub that is configured to relay the report to server 170. Sticker 102 includes a communicator 120, a power module 130, a configuration module 135, an awareness module 140, and a status tracker 150. In certain embodiments, sticker 102 communicates with a server 170 that is for example located “in the cloud” or similar database tart a single or distributed computer network and accessible via the Internet. Server 170 includes a tracking application 172 that tracks and records movement of sticker 102 based upon received information relating to sticker 102. For example, server 170 stores received location information of sticker 102 and also stores information as to other devices such as other stickers 102 and/or other tracking and communication devices that the sticker 102 has encountered. For example, sticker 102 may indicate that it communicated with or detected another network that may be identified and used to locate the sticker. Tracking application 172 thereby assembles a history of past determined locations of sticker 102.

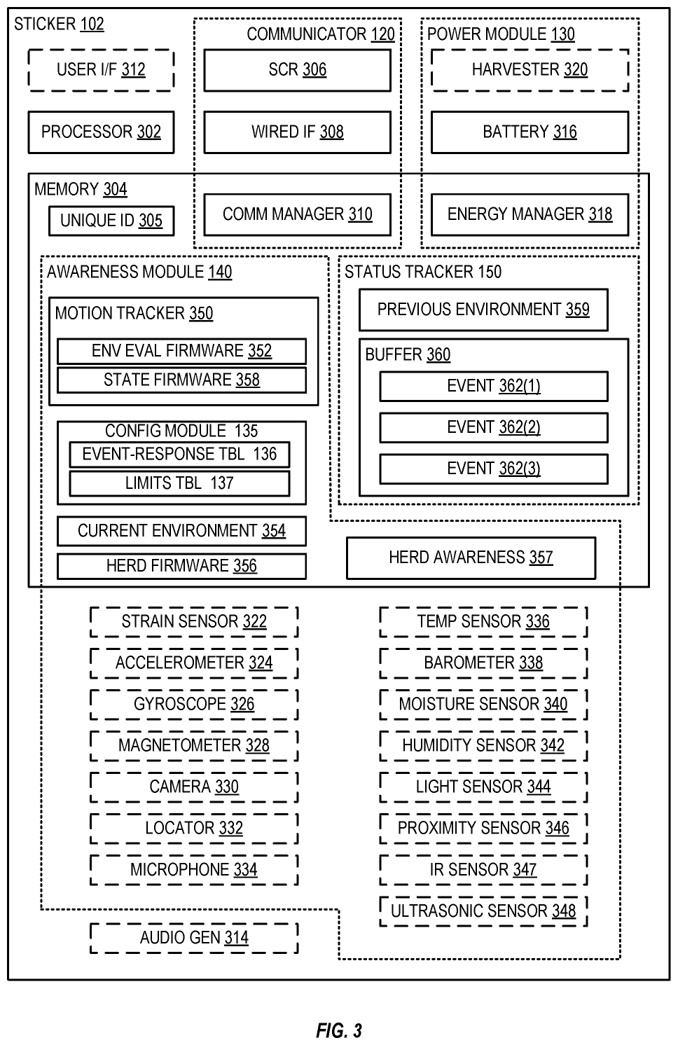

FIG. 2 shows sticker 102 of FIG. 1 implemented as a thin, flexible housing 206 containing electronics that may be attached to (e.g., stuck-on or affixed to) an asset 210. In the example of FIG, 2, sticker 102 has components 204 configured on a flexible printed circuit board assembly (PCBA) 202. In other embodiments, a rigid housing and rigid PCBA could be incorporated. To keep sticker 102 small, component packing e.g., chip scale packaging (CSP), may be used. For optimal longevity, housing 206 is weatherproof, waterproof and UV resistant to protect components 204 and flexible PCBA 202. In certain embodiments, sticker 102 has a layer of pressure sensitive adhesive 212 configured to attach it to asset 210. In certain embodiments, sticker 102 includes input/output devices such as a Universal Serial Bus (USB) configuration port, lights, screens, touch interface and/or buttons. However, these input/output devices are not required for the basic operation. In certain embodiments, it is envisioned that sticker 102 may resemble a sticker that attaches to asset 210 and may include branding. In certain other embodiments, sticker 102 is discreetly embedded into asset 210 internally, or attached externally and painted over, so that it is hidden from everyday view. Where sticker 102 is used with animals, such as livestock and pets, it may be attached to their ear, collar, protective gear, saddle, or may be inserted subcutaneously.

In an alternative embodiment sticker 102 lacks adhesive 212 and has a strap for attachment to asset 210. These embodiments are suited to being strapped to legs of young children and elderly people with dementia, to permit parents and caretakers to better track them. Many other types of fasteners could also be used to attach the sticker 102 to asset 210 including screws, bolts, nails, clips, pins and snaps.

In certain embodiments, functionality of sticker 102 is implemented within an app running on one or more smart devices selected from the group including: a smartphone, a mobile device, a smart TV, and other network-enabled devices. In these embodiments, where sticker 102 is implemented with an app running on a smart device, functionality of sticker 102 may take advantage of communication and location abilities of that smart device and use those abilities to transmit location signals over a network and may use these abilities to receive location signals from other stickers or existing tracking devices. Where functionality of sticker 102 is implemented in an app running on a srnartphone, for example, the sticker app may utilize the smartphone's ability to connect with Wi-Fi and cellular networks to signal its location as well as its ability to determine its location using built-in GPS. It may also use its GPS location to locate Bluetooth devices, such as existing tracking devices, that the phone might be connected to. Thus, the sticker app may continually and/or periodically determine its location, which may be refined with data from other sensors, networks, and peripherals, and sends this information to server 170.

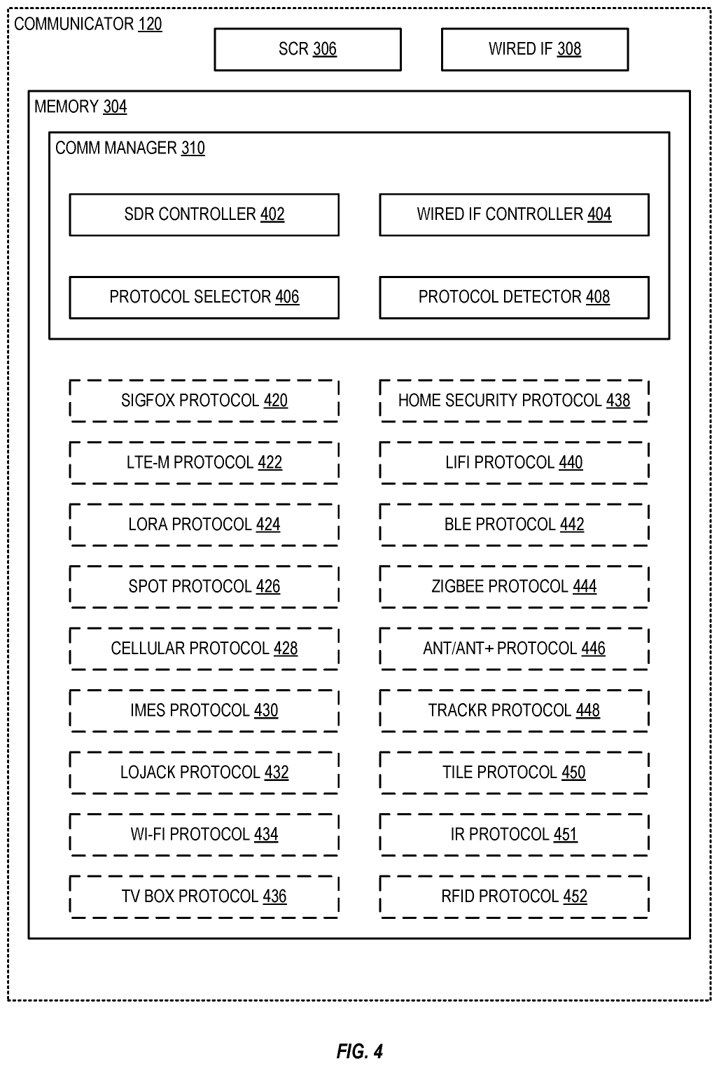

FIG. 3 shows sticker 102 of FIG. 1 in further exemplary detail. Sticker 102 is an electronic device and includes at least one processor 302 communicatively coupled with a memory 304. Processor 302 is, for example, a digital processor that executes machine readable instructions (firmware) stored within memory 304 to provide functionality of sticker 102 as described herein. Memory 304 may represent one or more memory types selected from the group including, but not exclusive to, RAM, SRAM, DRAM, ROM, PROM, Flash, magnetic and optical. In certain embodiments, processor 302 and memory 304 are implemented as a microcontroller. Processor 302 may have various operating modes, including a “sleep” mode where power consumption of processor 302 is minimized. Each sticker 102 is configured with a unique identifier 305 recorded in a nonvolatile memory component of memory 304 such as PROM or Flash memory that uniquely identifies it. Similarly, configuration module 135 includes configuration settings located in the nonvolatile memory component of memory 304.

In a particular embodiment, configuration settings of configuration module 135 include cell phone frequency bands authorized in a particular jurisdiction in which sticker 102 is sold since these may vary from country to country, Service Set Identifier (SSID) and encryption keys or passwords for IEEE 802.11-compliant (Wi-Fi) digital radio networks that the sticker is configured to access, power configuration and energy manager settings such as battery level and externally-connected power settings below which high-energy communications modes such as Wi-Fi and cell-tower communications are not to be attempted, and other similar settings. In an embodiment, these settings are configurable over a wired port (e.g. USB) of the sticker, and in other embodiments they are configurable using an encrypted wireless link to the sticker. In yet other embodiments, some settings of configuration module 135 of sticker 102 are configurable using buttons and a display of sticker 102.

### Power Sources

In certain embodiments, power module 130 is implemented as a battery 316 and an energy manager 318 that includes firmware stored within memory 304 and executable by processor 302 to manage power use by sticker 102 based upon power available through direct connections and energy stored within battery 316. In certain embodiments, where continuous power is readily available to sticker 102, battery 316 and energy manager 318 may be omitted. In certain embodiments, battery 316 is replaceable and sticker 102 provides access to allow a user to replace the battery. In another embodiment, the sticker 102 with battery included is sealed and intended for a one-time application. Energy manager 318 includes firmware and hardware adapted to tracking a state of charge of battery 316, thereby determining available energy stored within the battery 316. The available energy stored within the battery 316, as determined by energy manager 318, may be used to define operating modes of sticker 102, including whether high-energy communications protocols like cellular network communications are enabled, and to trigger low-battery status warning transmissions intended to notify server 170 of the low battery state; these transmissions may be relayed through other nodes of a herd to which sticker 102 belongs or by other stickers, or may be sent directly through a network sticker 102 has obtained access to. Upon receiving a low battery state, to reduce false alarms, server 170 may modify actions (e.g., disarming loss of signal alarms) taken when server 170 fails to receive signals originating at sticker 102.

Battery 316 allows sticker 102 to continue operation during power interruptions. In certain embodiments, sticker 102 includes an energy harvester 320 that harvests electricity from external sources to charge battery 316. Harvester 320 may represent one or more of a solar cell or panel, a thermal-electric generator, a piezoelectric or electromagnetic vibration generator, a tilt-driven generator, a wireless energy harvester (e.g., RFID), and other energy scavenging devices as are known in the art. In certain embodiments, harvester 320 is implemented as a magnetic inductive coupling to receive power magnetically and to charge battery 316. In certain other embodiments, adapted to be attached to oscillating machinery such as well pump-jacks, harvester 320 is a tilt-driven generator including a magnetic pendulum disposed so changes in tilt of sticker 102 causes pendulum movement relative to a generator coil.

In certain embodiments, sticker 102 is powered by the object it is tracking. For example, where sticker 102 is attached or embedded into an electronic device, sticker 102 may be configured to receive power from the electronic device. For example, sticker 102 may be embedded into the electronic device and directly attached to a power bus of the device, or couple to the electronic device via a power connector selected from the group including USB, Lightning, custom power cables, and other power connections known in the art of portable electronic devices.

In certain embodiments, sticker 102. includes a user interface 312 that allows a user to interact directly with sticker 102. For example, user interface 312 may include one or more of a display, which may be a touch-sensitive display, an input button, a visual indicator such as an LED, a capacitive or resistive input, and so on. Sticker 102 may also include an audio generator 314 that generates sound under direction of processor 302. For example, audio generator 314 may be activated to generate an alarm sound when sticker 102 determines that it, or the device it is attached to, is being transported without authorization, such as being stolen.

### Communication Networks

Communicator 120 allows sticker 102 to communicate with other devices. Communicator 120 of sticker 102 may include one or more single or multichannel software-configurable radio (SCR) 306 such as a software defined radio or any other conventional radio chipset that may operate with one or many software-configurable protocols at one or more or similar components, and a communication manager 310 with firmware that executes on processor 302 to cooperate to enable short and long range wireless communications and configure and control SCR 306. In certain embodiments, sticker 102 includes, in place of or in addition to SCR 306, a wired interface 308 that allows sticker 102 to communicate with wired networks. In certain other embodiments, sticker 102 includes both wired interface 308 and SCR 306 such that sticker 102 may communicate with both wireless networks and wired networks.

Utilizing one or both of SCR 306 and wired interface 308, communication manager 310 is configured to use one or more protocols to communicate with at least one wireless or wired network.

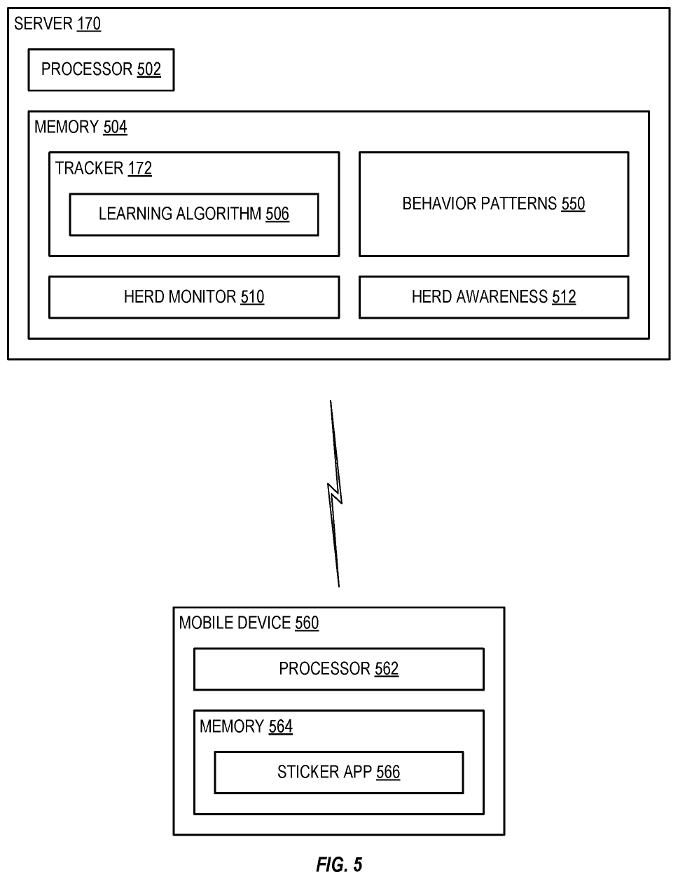

FIG. 4 shows communicator 120 of sticker 102 of FIGS. 1 and 3 in further exemplary detail. Communication manager 310 includes an SCR controller firmware 402 that configures and operates SCR 306 and a wired interface controller 404 that configures and operates wired interface 308. Communication manager 310 also includes a protocol selector 406 that selects one or more of a plurality of protocols 420-452 for use by controllers 402 and 404; communications manager 310 operates according to configuration information stored in configuration module 135 and a current energy status determined by energy manager 318. In the example of FIG. 4, memory 304 is shown storing configuration information and protocol firmware for several digital radio network types, including a SigFox (trademark of SigFox, Labège, France) protocol 420, a Long-Term Evolution (LTE) (trademark of European Telecommunications Standards Institute, Sophia-Antipolis, France)-protocol 422, a LORA (trademark of Semtech, Camarillo, Calif.) protocol 424, a SPOT protocol 426, a cellular-telephone protocol 428, an IMES protocol 430, a LoJack protocol 432, a Wi-Fi protocol 434, a TV box protocol 436, a home security protocol 438, a Light Fidelity (LiFi) (IEEE 802.15.7r1) protocol 440, a Bluetooth Low Energy (BLE) protocol 442, a ZigBee (IEEE 802.15.4) protocol 444, an ANT/ANT+ (trademark of Gamin, Olathe, Kansas) protocol 446, a trackR protocol 448 (a variant of Bluetooth 4.0), Tile protocol 450, and RFID protocol 452. In alternative embodiments, other protocols may be provided. Where any of these protocols require specific device pairing or SSID and encryption key or password combinations, necessary pairing information, SSID, passwords, and encryption keys are stored in configuration module 135. Memory 304 may include more or fewer protocols without departing from the scope hereof.

For configuring SCR 306, configuration module 135 and protocols 420-452 may define power and frequency rules for operating SCR 306, such that SCR 306 is configurable to implement both long range communications using cellular protocol 428 Wi-Fi 434, or SigFox 420 protocols, and short range communication such as Bluetooth Low Energy 442 or ZigBee 444 protocols that operates over short distances.

Using one of SCR 306 and wired interface 308, sticker 102 may communicate with a hub or router, such as a Wi-Fi router or a wireless network relay device or wireless network bridge, that in turn connects with one or more conventional networks such as the Internet, cellular telephone, or other networks known the art as operable over cable, optical, security, and electricity lines.

In certain embodiments, SCR 306 is configured for only low power operation and for transmit-only functionality. In other embodiments, SCR 306 is configured for both transmitting and receiving so it can operate as a transceiver in accordance with protocols, such as IEEE 802.11 that require collision detection, may assign local protocol addresses such as an internet protocol (IP) address, and provide for acknowledgment of packets. In certain embodiments, sticker 102 includes only wired interface 308 and communicates only via a wired network. In other embodiments, sticker 102 includes both SCR 306 and wired interface 308 and may selectively communicate via wired and wireless networks according to connection availability, configuration as stored in configuration module 135, and energy level as reported by energy manager 318.

Where sticker 102 includes SCR 306 and both high-power protocols (e.g., Sigfox protocol 420) and low power protocols (e.g., BLE protocol 442), protocol selector 406 selects the lower power protocol preferentially over high power protocols to minimize power usage if both high and low power networks are available. For example, communication manager 310 may first try to communicate using a low power protocol such as REID 452, BLE 442 or ANT/ANT+ 446 protocol, and when unsuccessful, then attempt to communicate using successively higher power protocol such as the Wi-Fi 434, Sigfox 420, and cellular 428 protocols. Once communication is established, communication manager 310 may learn of, or negotiate for, lower power protocols for future communication. That is, communication manager 310 implements a hierarchical strategy to reduce power consumption of communications by sticker 102 and thus allow sticker 102 to maintain network connectivity over a longer period without excessive battery drain. Once communication manager 310 successfully communicates (i.e., transferred information to a destination successfully as indicated by receiving a response packet), no further communication attempts are necessary and any further higher powered protocols are not used. The protocol used for successful communications may be stored for use during future periodic transmissions, so unsuccessful protocols need not be retried during every communications attempt although they may be retried at long intervals. Thus, communication manager 310 operates to communicate using the least amount of power necessary for the communication.

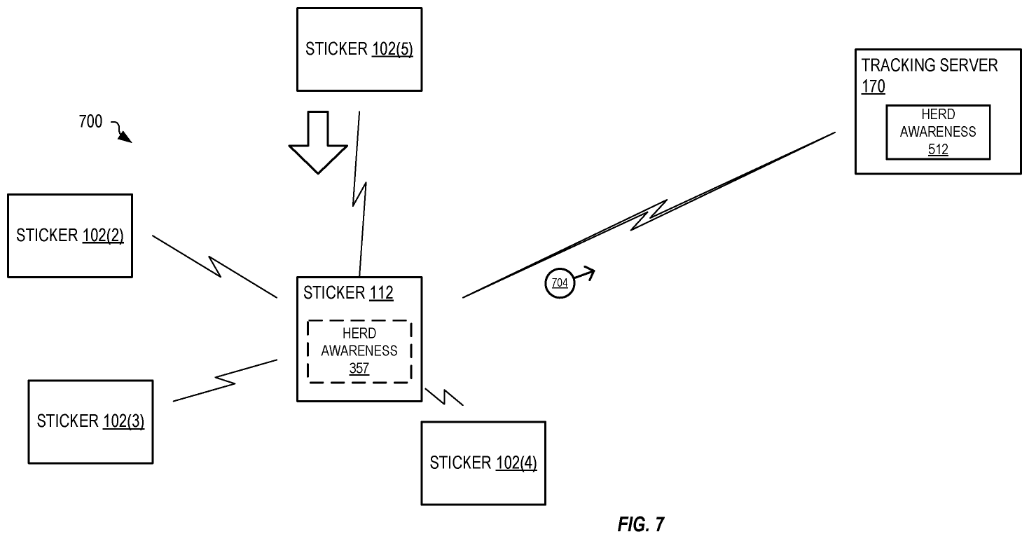

FIG. 6 illustrates one example scenario 600 where sticker 102 of FIG. 1 increases the communication range of an existing tracking device 602. Existing tracking device 602 periodically transmits a radio-frequency (RF) beacon signal, but is not within range of a corresponding tracking device 606, and therefore is not located by tracking 606. Communication manager 310 of sticker 102(1), which is in range of RE beacon signal 604, includes a protocol detector 408 that controls SCR 306 (or wired interface 308) to detect a protocol of a signal being received, which in this example includes RE beacon signal 604. In this example, protocol detector 408 periodically configures SCR 306 to “listen” for signals from different types of existing tracking devices by configuring SCR 306 to receive on a particular frequency, and then processing any received signal to determine a protocol being used for that signal to recognize tracking devices. Where protocol detector 408 identifies a received signal as using Tile protocol 450, protocol detector 408 and/or communication manager 310 may determine that the signal is from an existing tracking device of the “Tile” brand. Communication manager 310 may then either reconfigure SCR 306, or configure another channel of SCR 306 as appropriate, and retransmit the received RF beacon signal 604 as RF beacon 614 using the detected protocol thereby extending the operable range of the Tile tracking device. In alternative embodiments, sticker 102 may log identity information from the received beacon signal, then reconfigure SCR 306, configure another channel of SCR 306 or enable and configure a dedicated GPS integrated circuits as a GPS receiver and obtain a current GPS location, then reconfigure SCR 306, or configure another channel of SCR 306, to interface with the last network over which it successfully communicated, and send the identity information and GPS location to server 170. Also, by locating sticker 102 relative to existing tracking device 602 (e.g., a “Tile” device), logging and thereby tracking of sticker 102 is further enhanced, since server 170 may collect additional location information to locate sticker 102, should the need arise. Server 170 may collect many different kinds of information relating to sticker 102, and may use that information to determine an approximate location and track movement of sticker 102, even where direct location and tracking information for sticker 102 is unavailable. RF beacon 614 is detected by existing tracking device 606 and is thus aware of existing tracking device 602.

In another example of operation, communication manager 310 relays information of RF beacon signal 604 as message 624 using an alternate protocol via wired interface 308 and/or SCR 306. That is, sticker 102 forms a bridge between two different networks that may or may not use different protocols. Continuing with the above example of RF beacon signal 604 received from existing tracking device 602, communication manager 310 sends information (e.g., time, proximity and location of other known devices and networks) of RE beacon signal 604 via SCR 306 using Wi-Fi protocol 434 to server 170. In turn, server 170 identifies a partner server 608 of existing tracking device 602 and forwards the information to the existing partner server 608. For example, server 170 may identify partner server 608 based upon the detected protocol and/or information of RF beacon signal 604 contained within message 624. Thus, information of existing tracking device 602 is bridged by sticker 102(1) and server 170 to partner server 608 corresponding to existing tracking device 602.

In certain embodiments, each protocol 420-452 defines a web address or URL of a server associated with information received via that protocol, and communication manager 310 of sticker 102 forwards the information of RF beacon signal 604 directly to partner server 608 using Wi-Fi 434 protocol for example.

In a system having multiple sticker location devices 102(1), 102(2), as illustrated in FIG. 6, sticker 102(1), upon detecting RF beacon signal 604, may determine its location, such as by using its SCR as a GPS receiver or by using a separate GNSS/GPS chipset as locator 332, and include this location within message 624, thereby providing existing partner server 608 with an estimated location of existing tracking device 602. Thus, sticker 102 effectively operates similarly to existing tracking devices 606. In an alternative embodiment, to reduce local sticker processing requirements, sticker 102(1) may transmit GPS or similar satellite identity and time differences between satellite signals to server 170, expecting server 170 to use this information to determine a location of sticker 102(1).

In another example of operation, protocol detector 408 identifies a received signal as being from another sticker 102. For example, sticker 102(2) may receive signal 634 from sticker 102(1). Within sticker 102(2), communication manager 310 processes the received signal, which indicates that sticker 102(1) is unable to communicate with server 170. Communication manager 310 of sticker 102(2) then forwards information of signal 634 as message 636 to server 170 via a previously used path, or attempts to forward the information via an alternative path and/or protocol; if sticker 102(2) is configured to allow higher power operation or additional protocols than sticker 102(1) or is subject to different signal obstructions than sticker 102(2), sticker 102(2) may get through to server 170 while sticker 102(1) could not—this is particularly likely if sticker 102(1) is conserving battery energy by restricting itself to low-power protocols like the BLE protocol, while sticker 102(2) is drawing power through a power cable and allowing itself to use high-power protocols like the cellular telephone protocol. Where server 170 sends a response to sticker 102(1), communication manager 310 of sticker 102(2) may retransmit this response in the protocol used by sticker 102(1) such that it is received by sticker 102(1). Thus, communication manager 310, operating within each sticker 102, is able to form a mesh network of multiple stickers to relay information between sticker devices 102 and server 170. Where one sticker 102(1) receives RF beacon signal 604 from existing tracking device 602, communication manager 310, operating within each sticker 102, may utilize the formed mesh network to also convey information of the existing tracking device. More than one sticker device 102 may be involved in relaying information from a sticker to and from server 170.

With the option of being equipped with SCR 306, sticker 102 may selectively receive RE signals in various frequency bands. In certain embodiments, sticker 102 may process received signals itself. If sticker 102 has sufficient processing power and energy levels, sticker 102 may immediately process a received signal and communicate information regarding that signal to one or more of server 170, other stickers 102 in the immediate area, and to other devices. If the processing power or energy level of sticker 102 is insufficient, then processing of the received signal may be delayed until energy is sufficient, or information of that signal may be passed to one or more other devices by only low power modes. If passed to another device, that other device may have sufficient energy to reach server 170. In certain embodiments, sticker 102 transmits and/or streams the received signal to server 170 for further processing.

In other embodiments, SCR 306 may be configured to receive various RF signals including cell phone signals in different hands/different protocols, IEEE 802.11 wireless network signals, satellite navigation signals, direct video broadcast (DVB) TV signals, and any other signal within one or more VHF/UHF frequency bands may be received by sticker 102. For purposes of this document, satellite navigation signals include one or more of global satellite-based navigation systems such as Russia's GLONASS, the United State's GPS (Naystar), the European Union's Galileo, China's BeiDou or BeiDou-2, regional satellite-based navigation systems such as India's IRNSS (NAVIC), and satellite navigation enhancement signals such as WAAS, GAGAN, or similar systems; these may operate in different frequency bands.

In some embodiments, location is determined from satellite navigation signals.

By receiving and decoding (either within sticker 102 or in server 170) these various other types of signals, information within the received signal may provide additional means to determine a location of sticker 102. For example, IEEE 802.11 wireless network signals transmitted from Wi-Fi access points and routers typically include an SSID field that identifies the network and can be received and logged. For example, by receiving a particular signal, sticker 102 (or server 170) may determine a location of sticker 102 relative to a known location of a source of that signal type and content and signal strength. Where multiple such signals are received, sticker 102 and/or server 170 may triangulate a location of sticker 102 as backup to GNSS or GPS location. Further, SCR 306 provides flexibility to support new wireless communication standards by firmware upgrade without needing to modify the hardware platform.

In alternative embodiments, instead of SCR 306, sticker 102 incorporates one or more digital radio circuits. These digital radio circuits provide functionality for those protocols and bands that they are adapted for operation with; particular digital radio circuits that may be incorporated within sticker 102 include IEEE 802.11 compatible digital radio circuits, digital cell telephone network compatible radio circuits, Bluetooth-compatible radio circuits, and other digital radio circuits as known in the art of digital radio, In embodiments having such radio circuits configurable for more than one protocol, or where radio circuits for more than one protocol are provided, the signal relay and other functions described with reference to SCR 306 are supported where compatible with the provided digital radio circuitry.

### Awareness

Awareness module 140 includes intelligence, such as motion tracker 350 firmware that utilizes environmental information from one or more sensors 322-348 to determine and/or track movement, motion, and/or changes in the environment of sticker 102. As shown in FIG. 3, sticker 102 includes one or more sensors, such as one or more of a strain sensor 322, an accelerometer 324, a gyroscope 326, a magnetometer 328, a camera 330, a GNSS/GPS locator 332, a microphone 334, a temperature sensor 336, a barometer 338, a moisture sensor 340, a humidity sensor 342, a light sensor 344, a proximity sensor 346, IR sensor 347, and an ultrasonic sensor 348; the awareness module 140 and motion tracker 350 in some embodiments operates in conjunction with SCR 306 of communicator 120, using SCR 306 to receive and log radio signals, or “sniff” from the local environment, including, for example, 802.11 receiving wireless network signals, such as those transmitted from access points and routers, the signals having an SSID field having contents that identifies each 802.11 network. In addition to SSID's, any MAC addresses and IP addresses received while listening to and recording information from (known as sniffing) wireless networks are recorded. Similarly, awareness module 140 and motion tracker 350 in some embodiments records the Cell IDs (CID) of nearby cellular telephone base stations. Since most cellular telephone base stations are stationary and at known locations, and many, but not all, 802.11 access points and routers are also stationary, logged SSID, MAC, and CID information can provide location information useful as a backup to satellite navigation locations.

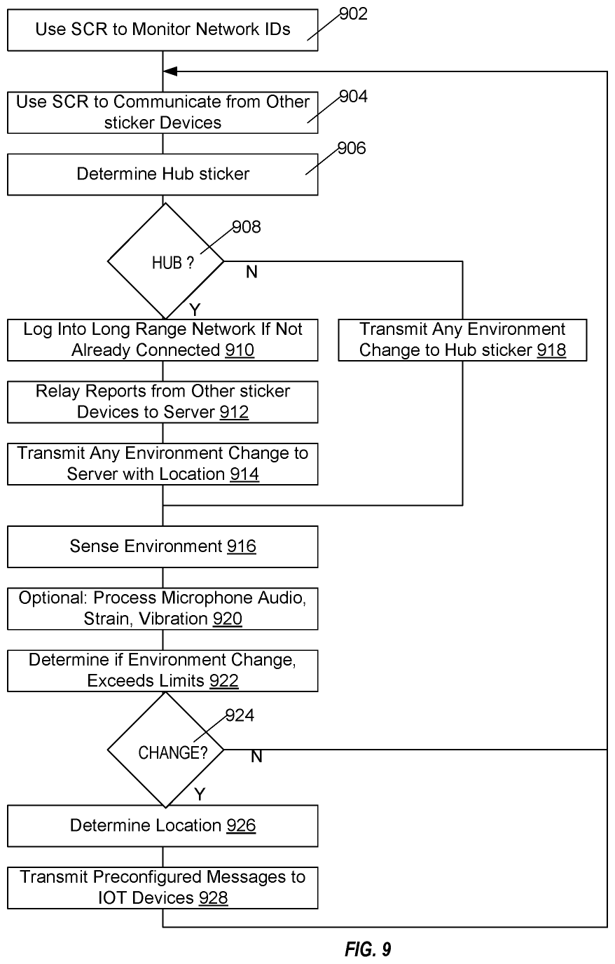

In an alternative embodiment, sticker 102 monitors microphone 334, and classifies sounds that are heard, including for example child crying, glass breaking, screech of a failed bearing, horn blowing, or gunshot. Sound classifications are then checked against a list of sound. classifications and desired actions in an event-response table 136 configuration module 135, and if a sound is detected and classified as a sound with a designated response, a message indicating that the sound has been detected is transmitted to server 170 and mobile device 802 (FIG. 8), and, in some embodiments, an associated preconfigured command is transmitted to a local alarm 814 or Internet of Things (IOT) device 818. In this way, sticker 102 may serve as a baby monitor, bearing-failure indicator, or a window-breakage alarm according to the configuration, and activate an alarm or turn on lights when particular sounds are detected.

Motion tracker 350 has firmware including machine readable instructions that are stored in memory 304 and executed by processor 302. Motion tracker 350 may include an environmental evaluator firmware 352 that, at least periodically, processes information from one or more sensors 322-348 and SCR 306 to determine a current physical and RF environment 354, temporarily stored in memory 304, of sticker 102. Current environment 354 may indicate one or more of acceleration, rotational movement, magnetic orientation, ambient light level, a current geographic location, ambient noise level, ambient temperature, ambient barometric pressure, ambient humidity, proximity to other objects, a photograph of surroundings, a pattern of SSID and CIDs received by listening to and recording information from (known as sniffing) the local digital radio environment, and current information observed by any other sensors of the sticker.

Environmental evaluation firmware 352 compares current environment 354 to a previous environment 359 that was previously determined and is stored within status tracker 150 in memory 304 to determine environmental changes that, when significant based upon one or more environmental change thresholds stored in configuration module 135, may indicate an event that is important to sticker 102. For example, where accelerometer 324 indicates a series of accelerations over a period of time, environmental evaluation firmware 352 may determine that sticker 102, and thus the asset it is attached to, is being moved. Motion tracker 350 may then generate an event 362(1), stored within buffer 360 of status tracker 150 in memory 304, to indicate the detected movement, and, if server 170 is reachable, information regarding the movement transmitted to server 170. Event 362(1) may be timestamped with one or more of a date and time, and a type, of the determined movement and may indicate an amplitude and duration of that movement and stored in status tracker 150 memory.

In an exemplary embodiment, in comparing current environment 354 to previous environment 359, environmental evaluation firmware 352 and/or state firmware 358 may also determine that ambient temperature has dropped suddenly by a temperature difference greater than a threshold, whereupon motion tracker 350 generates event 362(2) indicating at sticker 102 has been moved from a warm environment to a cool environment. Motion tracker 350 may thereby deduce, based upon both events 362(1) and 362(2), that sticker 102 has been moved from an indoor location to an outdoor location and generate an event 362(3) indicating that relocation. If current energy levels and network connectivity permits, communication manager 310 may immediately communicate event 362(3) (and optionally events 362(1) and 362(2)) to server 170, without waiting until a next scheduled periodic update, whereupon tracking application 172 utilizes event 362(3) (and optionally events 362(1) and 362(2)) to track movement of sticker 102 and the associated asset and to send a movement notification message to a user.

Sensors 322-348 may have additional uses within sticker 102. For example, locator 332 may be implemented as a GPS receiver that provides precise location sensing. Accelerometer 324, gyroscope 326, and magnetometer 328 may provide one or more of: rough estimates of speed and displacement through mathematically integrating accelerometer signals; direction and cadence may be determined; power metrics may be estimated. From this data, strains, stresses and deformations could also be inferred. Sticker 102 may also be configured to modulate frequency of a transmitted RF beacon signal based upon detected movement. Sensors 322-348 may also be used to determine status and health when configured with machinery. For example, a change in vibration levels or other sensor inputs may indicate a change of state in the machinery or may indicate deterioration in performance of the machinery that might otherwise go unnoticed. Microphone 334 and/or audio generator 314 (e.g., a speaker) may be used to listen to the environment to aid in determining what is normal and what are unusual events. Audio generator 314 may, for example, be used to make an audible alarm if sticker 102 suspects that it is being stolen.

In an embodiment, strain sensor 322 is read to by processor 302 of sticker 102 and compared to preconfigured strain limits in configuration module 135. Periodic fast-Fourier transforms of a sequence of readings of strain sensor 322 and accelerometer 324 are performed to determine vibration frequencies and magnitudes. These vibration frequencies and magnitudes, together with peak readings of the strain sensor 322 and accelerometer 324, are compared to limits in a limits table 137 in the configuration module and, upon these limits being exceeded, desired actions in an event-response table 136 of configuration module 135 are retrieved. Comparable time domain processing methods may also be used to determine the amplitudes and frequencies of the measured signals. Actions set in the event-response table 136 for excessive vibration or excessive strain may include sending a message indicating that over-limit strain or excessive vibration has been detected to server 170 and mobile device 802 (FIG. 8), and, in some embodiments, an associated preconfigured command is transmitted to a local alarm 814 or IOT device 818. In a particular embodiment, sticker 102 is attached to an oil-well pump-jack, IOT device 818 is an internet-accessible power switch coupled to control power to the pump-jack, and the preconfigured command turns off the pump-jack upon sticker 102 detecting excessive strain or vibration in the pump-jack.

Temperature sensor 336, barometer 38, moisture sensor 340 and humidity sensor 342 may allow sticker 102 to determine an environment/location of its associated asset by examining the ambient conditions. In one embodiment, sticker 102 is configured to generate an alarm when it gets wet. Temperature sensor 336 may also allow sticker 102 to detect changes in asset state, such as overheating or if the machine has expectantly stopped and cooled down.

Light sensor 344, proximity sensor 346, IR sensor 347, ultrasonic sensor 348, and camera 330 may allow sticker 102 to provide clues as to where it currently is located. In a particular embodiment, a high-power LED or laser-diode is configured with light sensor 344, camera 330, or IR sensor 347 and configured to operate as a lidar to provide additional information about the environment where sticker 102 is located. Once information is gained from lidar operation, this is transmitted to server 170 for use in physically locating sticker 102.

Light sensor 344 and an associated LED may in some embodiments allow sticker 102 to implement LiFi data communication and may allow sticker 102 to implement power savings, by waking up other components of sticker 102 such as locator 332 (GPS) when daylight is detected and sticker 102 is equipped with an energy-harvester 320 incorporating solar cells.

Ultrasonic sensor 348 may be used to determine a distance between sticker 102 and other surfaces in the vicinity. For example, ultrasonic sensor 348 aids in determining the type of building or enclosure in which sticker 102 is located. Signals from ultrasonic sensor 348 may be processed by sticker 102 and/or by server 170. For example, where processing power and/or power levels within sticker 102 are low, but sufficient for communications, signals from ultrasonic sensor 348 are sent to server 170 for analysis, such as to determine characteristics of the building's structure.

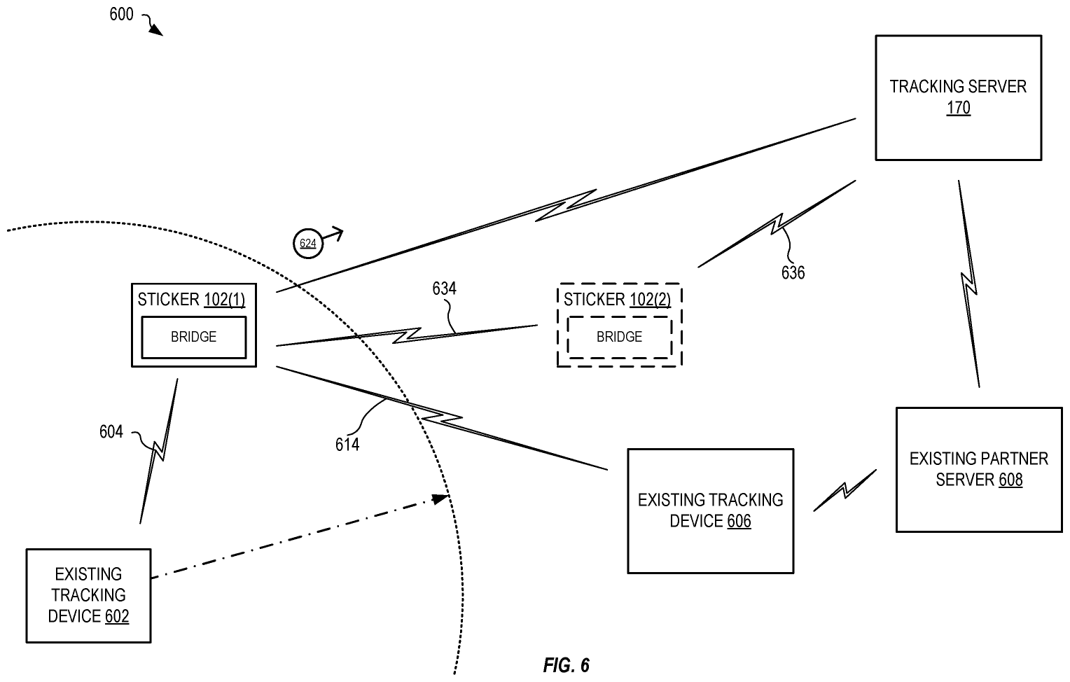

In an alternative embodiment, ultrasonic sensor 348 is configured to emit ultrasound into asset 210 to which sticker 102 is attached. When operated in this mode, the ultrasonic sensor is configured to detect surfaces, such as the interface of pressure sensitive adhesive 212 with the asset 210 to which it is attached, and may additionally detect surfaces within the object. In these embodiments, awareness module 140 records reflectivity and distance to these surfaces, and status tracker 150 is configured to observe significant changes in reflectivity and distance. Upon detecting significant changes in reflectivity and distance of these surfaces indicative of detachment of sticker 102 from asset 210, such as a change in reflectivity of the interface of adhesive 212 with asset 210 and an increasing range to surfaces within the object, sticker 102 is configured to transmit a message to a mobile device (e.g., mobile device 560, FIG. 5), or tracking server 170, warning that asset 210 and sticker 102 have separated.

In yet another embodiment, awareness module 140 is configured to communicate with SCR 306 of communicator 120 and to use a transmitter of SCR 306 to periodically emit a brief pulse at a radiolocation wavelength, and configures a receiver of SCR 306 to receive at that radiolocation wavelength. As known in the art of radar systems, such pulses at radiolocation wavelengths are reflected in part by surfaces of nearby objects. SCR 306 receives reflected signals and determines reflection strength and a time of flight to those surfaces, thereby observing reflectivity and distance to these surfaces. In this embodiment, status tracker 150 is configured observe significant changes in observed reflectivity and distance. Upon detecting significant changes in reflectivity and distance of these surfaces indicative of detachment of sticker 102 from asset 210, sticker 102 may be configured to transmit a message to a mobile device (e.g., mobile device 560, FIG. 5), or tracking server 170, warning that asset 210 and sticker 102 have been potentially relocated. Strain sensor 322, which may include strain gauges and/or wire embedded into sticker 102 may be used to detect strain and/or stress applied to sticker 102 and may be used to structural monitoring or to detect when sticker 102 is being removed from its associated asset. In certain embodiments, sticker 102 is configured to emit an alarm signal when it detects that it is being removed from an asset, and, if server 170 is reachable, transmit an alert message to server 170.

### Off-Line Recording of Data

In certain embodiments, memory 304 implements one or more first-in, first-out buffers 360 that store events 362 over finite periods of time when sticker 102 is unable to communicate with server 170. For example, events 362 may remain within buffer 360 until communicated to server 170 or until buffer 360 becomes full, when the oldest event 362 is discarded to allow a new event 362 to be inserted into buffer 360. Thus, events 362 are not immediately lost due to a temporary loss of communication with server 170. When sticker 102 reconnects with server 170, sticker 102 may transfer all “waiting” events 362 from buffer 360 to server 170 using a most power efficient communication method available. In certain embodiments, tracking application 172 on server 170 processes received events 362 and generates a report summarizing events of sticker 102 for an interested user.

### Expected Behavior Patterns

FIG. 5 shows server 170 of FIG. 1 in further exemplary detail. Tracking application 172 processes events 362 from sticker 102 to determine a current geographic location of sticker 102 and a current situation of sticker 102. For example, tracking application 172 may include one or more learning algorithms 506 that track and store behavior patterns 550 of sticker 102 such that a “normal” and thus “expected” behavior of sticker 102 is determined. When processing newly received events 362 from sticker 102, tracking application 172 may determine whether these events 362 indicate “normal” and/or “expected” behavior of sticker 102, or whether these new events 362 indicate unexpected behavior that needs clarification with the user. For example, consider where sticker 102 is attached to a bicycle that the user frequently takes out of a garage early in the morning and rides for one hour. Tracking application 172, upon processing of events 362 from sticker 102 determines that sticker 102 exiting the garage in the mornings is normal behavior. When tracking application 172 receives one or more new events 362 that indicate that sticker 102 has moved out of the garage at eleven in the evening, tracking application 172 determines that this is not “normal” behavior and may interact with the user to confirm that this is OK and/or to raise an alert. Interaction with the user may be by SMS text message to a cell phone, by email, by synthesized-voice telephone call, or other methods of rapidly contacting users that are known in the art, according to a configuration of tracking application 172. In addition to trying to make connection with the user, other alarms can be set and transmitted through the network.

FIG. 5 also shows a mobile device 560 with a processor 562 and a memory 564. Mobile device 560 is selected from the group including a smart phone, a tablet, a laptop, and other mobile computing devices. Memory 564 of mobile device 560 is configured with a sticker app 566 that includes machine readable instructions executed by processor 562 to enable mobile device 560 to communicate with sticker 102 and/or server 170. For example, sticker app 566 facilitates configuration of sticker 102 and may provide notifications of events detected by sticker 102 and/or server 170.

### Modes of Operation

Sticker 102 may be configured to operate in one or more operational modes. In a simple broadcast mode, sticker 102 emits an RF beacon signal at regular or irregular intervals. The RF beacon signal may be detected by one or more devices that may operate to determine a position of sticker 102 by measuring signal strengths and calculating from known positions of stationary receivers and approximate positions of moving receivers. In addition to this, angle-of-arrival techniques may also be used in some embodiments having where a receiver, such as an 802-11n router, which has multiple antennae to help determine the direction and distance of sticker 102 from the receiver. In another example, sticker 102 may determine angle of arrival of signals by measuring signal arrival times and/or phase offsets at different antenna locations.

Sticker 102 may operate in a state change enabled broadcast mode, where sticker 102 utilizes a state firmware 358 and one or more of sensors 322-348 to detect a threshold change, wherein a change of state signal is broadcast. Where no change of state is detected by state firmware 358, then sticker 102 may remain silent or continue emitting periodic or aperiodic RF beacon signals.

Sticker 102 may be configured with a programmable and low power “wake-up receiver”. This type of radio receiver operates at very low power to detect radio activity at a certain frequency. Once radio activity exceeding a threshold is detected at the certain frequency, the wake-up receiver generates an interrupt signal that awakens processor 302. This wake-up process may be triggered based on reception of a certain signal pattern or by any activity exceeding predetermined signal strength. The use of a wake-up receiver reduces power consumption of sticker 102 since processor 302 may be put into a deep sleep, low power mode until a specific or general type of radio activity is detected in the surrounding environment or an internal timer times out.

Where at least two stickers 102 are located within communication range of one another, they may share environmental information. For example, where each sticker 102 is configured with different combinations of sensors 322-348, each may learn additional environmental information from the other stickers 102. Where each sticker 102 has similar sensors, sensed information may be shared and compared to determine additional information about the environment. For example, if each sticker 102 includes at least one accelerometer 324, where multiple stickers 102 simultaneously detect movement, they may determine that either an earthquake or movement in a vehicle has occurred. If multiple stickers 102 indicate an increase in temperature, they may determine that there is a fire or that an air conditioning has been shut down, and they are likely in a same building or room. In a similar manner, information from different classes of sensors within sticker 102 or between several stickers 102 may be combined using sensor fusion to learn more about the local environment.

In an alternative embodiment, a first and a second sticker 102 may be configured to compare their sensed environment and report any significant difference in their environment. This configuration is particularly useful where high and low value equipment is in the same laboratory. A thief is unlikely to be able to transport all equipment in the lab. If a thief places the high value equipment in a backpack, box, or suitcase, while leaving the low value equipment on a workbench, at least ambient light levels at the high and low value equipment will differ, permitting stickers attached thereto to transmit an alarm message.

In a similar manner, information from multiple sensors may be combined to provide additional location information. For example, a barometer may provide height or floor information, while UPS or other sensors such Wi-Fi, ZigBee, SigFox, LTE-M, Bluetooth, and ANT radios may be used for horizontal positioning. Light sensors and/or ultrasonic sensors may be used to determine in which room sticker 102 is located, while two-way time-of-flight ranging of ultrasonic sensors or radio pulses are used to determine distance from nearby stickers 102 or other supported devices. In addition to this, a barometer from sticker 102 could be used to help constrain the UPS height estimation from that same sticker. In a similar fashion a Wi-Fi signal could be used to improve the acquisition time of a GPS signal and its positional accuracy.

In another embodiment, sticker 102 also includes a herd firmware 356, wherein two or more stickers 102 form a herd and various properties about the herd may be determined. These herd related properties might include, but are not limited to the number of members, relative position and current state (e.g., moving, stationary, and so on). These improved RxTx (transceiver) sticker locator devices can communicate with each other to determine herd size, member properties, and can recognize a new sticker as a member and add it to the herd, etc. without relying on other network servers to perform those functions.

Where a first sticker 102 is configured as a transceiver, other stickers 102 may operate as transceivers, may transmit only, or may operate as transceivers until a hub sticker is designated and then transmit mostly, receiving seldom. First sticker 102 may determine it should operate as a “hub” sticker 112 that aggregates signals from other stickers of a group or herd. Hub stickers 112 and stickers 102 may be identical, or in some embodiments specific stickers may be configured for operation as huh stickers 112. In a particular embodiment, hub sticker 112 has additional energy harvesting capability, such as a larger solar panel or additional solar cells for harvesting solar energy, or a heavier pendulum and larger coil for harvesting energy associated with tilting, than other stickers 102 to provide the additional energy needed for communications with the other stickers and long range communications such as to cell phone towers. In another particular embodiment, hub sticker 112 is physically identical to other stickers 102 but has been configured by a user to act as a huh sticker. In yet another particular embodiment, stickers 102 communicate their energy levels, and a sticker 102 is selected from those stickers in contact with the greatest number of stickers of the herd and/or having greatest energy is designated as hub sticker 112; in this embodiment the designation of huh sticker 112 may be automatically rotated among stickers 102 to distribute power consumption among stickers 102.

When operating as a hub, sticker 112 may operate its own local network and collect signals directly from other stickers 102 in its vicinity, and, where sticker 112 can communicate directly with some but not all stickers 102, also collect signals from other stickers 102 that are relayed through a sticker 102 that is in direct communication with sticker 112. Then, when prompted and/or periodically, hub sticker 112 uploads captured signals relating to environmental changes and/or environmental data directly through a cellular or Wi-Fi network to server to tracking server 170, or to any nearby device adapted for communication over networks such as Sigfox, cellular, Wi-Fi or similar and which can reach tracking server 170. Signals from other stickers relating strictly to network organization and configuration are not relayed. In certain embodiments, hub sticker 112 is in continual contact with one or more of the above-mentioned networks. In other embodiments, all stickers 102 in a herd communicate with an existing non-sticker hub, such as one of an existing Sigfox or cellular tower, a router, a smart TV, and so on. That is, the existing hub enables herd awareness within two or more stickers 102. In a particular embodiment, stickers in a herd cooperate to determine a designated hub sticker 112, preferentially assigning a sticker with external power available and a high-energy state to this role; once a huh sticker 112 is designated, stickers not designated as hubs may conserve power by only enabling their transmitters and receivers momentarily to transmit periodic or non-periodic status reports and receive acknowledgements of their transmissions. In one embodiment, server 170 implements a herd monitor 510 that receives and tracks herd information determined by hub sticker 112. When server 170 identifies that one or more members are missing from the herd, a search is enabled over the broader network to see if the missing member(s) show up in another place or are added to another herd, if the missing member cannot be located, server 170 may contact the owner. Alternatively, notification of its location could be sent to the owner when a sticker belonging to one herd joins a different herd.

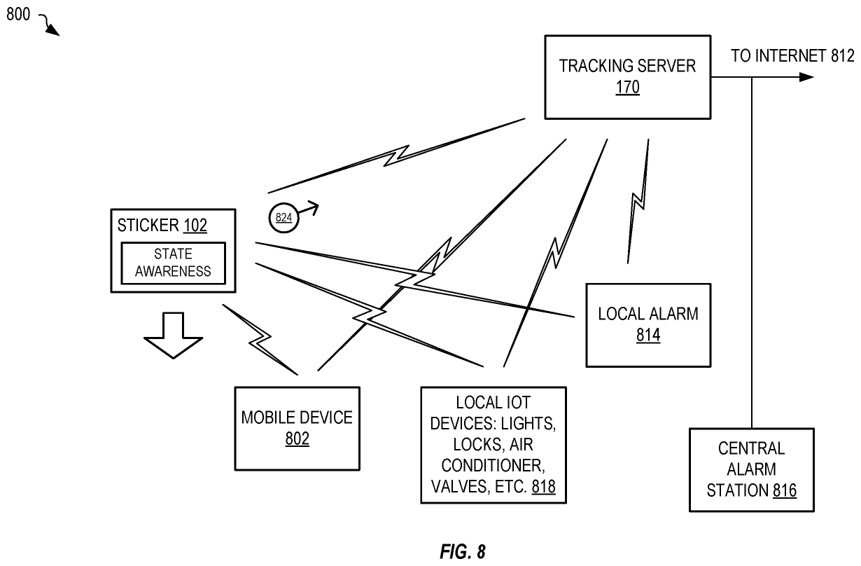

FIG. 7 shows one exemplary herd 700 including stickers 102(2)-(4), where sticker 112 has become designated as a hub sticker and is configured as a transceiver and maintains herd awareness 357. In one embodiment, sticker 112 operates as a communication bridge that communicates directly with stickers 102(2)-(4) and relays information from these stickers 102(2)-(4) to server 170, where herd monitor 510 of server 170 maintains herd awareness 512.

In one embodiment, when a new sticker 102(5) moves into the area of herd 700, it is detected by sticker 112 and may be automatically added to herd 700. In another embodiment, when the new sticker 102(5) moves into the area of herd 700, it is detected by sticker 112, and sticker 112 generates message 704 indicating the arrival of sticker 102(5) to server 170. In certain embodiment, sticker 102(5) is configured in an add-to-herd mode (for example by pressing a button on sticker 102(5)); whereupon sticker 102(5) transmits a signal that indicates that it should be added to herd 700. In another embodiment, a button on sticker 112 is pressed, or (or some other suitable input signal provided) causing sticker 112 to include any new stickers 102 within range into herd 700.

Where all stickers 112, 102(2)-(5) are configured as transceivers, each sticker 102/112 may implement herd awareness 702, wherein any one of stickers 102/112 may send a status of herd 700 to server 170 via any available network such as Sigfox, and others.

Where any one sticker 102/112 that s a member of herd 700 goes missing (i.e., goes out of range, fails to operate, fails to communicate, etc.), then remaining stickers 102/112 of herd 700 and/or server 170 may detect the absence of the herd member and raise an alert. In one embodiment, where sticker 102(3) determines that it is unable to communicate with other members of herd 700, it may attempt to send a message indicating contact with herd 700 has been lost to server 170 via any available network. Any member of herd 700 that determines loss of any other member from herd 700 may also generate a message to notify other herds of the loss, such that members of the other herds may help locate the missing member. When communication with a broader network is possible, the hub (e.g., sticker 112 operating as the hub) of any herd updates server 170 with any added or lost herd members. In this manner, server 170 may be alerted to query nearby herds to determine if the missing herd member was added to another herd. Server 170 may include a missing sticker list to which unique ID 305 of any missing sticker 102 is added. When server 170 learns a new unique ID 305 (e.g., when a sticker 102 is added to a herd), that ID can be checked against the missing sticker list and identify a sticker as corresponding to a previously lost sticker so appropriate action may be initiated.

### Crowdsourcing

Where a tracked asset becomes lost (i.e., where the asset is moved and no longer in an expected location), any other receiving device such as another sticker 102, a router, a mobile device, a cellular network tower, a Sigfox tower, or a smart TV set, may be used to detect a signal transmitted by a sticker 102 attached to the asset. For example, any such communication device within the operating range of the tower is registered so the tower builds a history of the communication including time, date, a device ID such as a cellular telephone mobile equipment identification number (MEID) or other unique ID 305, and signal strength. Server 170 may thereby utilize an application programming interface (API) executing on the tower to retrieve the history information for a particular device. For example, where a tower detects a transmitted signal from sticker 102 attached to the lost asset, server 170 may use associated APIs of service providers to “search” for any tower that the missing sticker 102 has registered with. Server 170 may then determine an approximate location and/or movement direction of the asset based upon the location of the tower and optionally from information received from other towers that have registered missing sticker 102.

This crowdsourcing ability is greatly enhanced when a mobile software application is widely available to detect an RF beacon transmission from sticker 102. For example, this application running on smartphones and other such mobile devices may contribute towards locating a missing asset. A reward may be offered for finding missing assets to encourage use of the app on mobile devices.

Advantageously, neither the missing asset with sticker 102 nor the receiving mobile device need be connected to another network when the RF beacon signal is detected by the mobile device. Rather, when the RF beacon signal is detected, the mobile device may activate its GPS receiver or otherwise remember the detection location such that when the mobile device reconnects to a wide area network such as a cellular network, or a Wi-Fi network, the missing asset's approximate location may be reported to server 170.

Where a detected RF beacon signal cannot be interpreted, the frequency band(s) of the received signal and its approximate location may be reported to server 170. Where sticker 102 is about to lose power, sticker 102 may transmit a message indicating its low-power status. Thus, other devices in range, or in the same herd, may report a last known location of the device before it failed.

### Examples of Use

Sticker 102 may he used to track any object, animal, or human. For example, sticker 102 may be used to track people, such as children, aging parents, or people who have legally restricted movement such as sexual offenders, and parolees. Sticker 102 may be used to track small, frequently misplaced items, such as keys, wallets, phones, and eyeglasses. Sticker 102 may be used to track sports equipment such as skis, racquets, surfboards, paddle-boards, electronic devices like TV's, computers, tablets, phones, transportation devices like bicycles (human powered, electric assisted and fully electric), cars, motorcycles, trucks, vans, railroad cars, and water vessels including powered boats, sailboats, canoes, kayaks, carts, skateboards, and hoverboards. Sticker 102 may be used to track valuables in homes or businesses such as paintings, vases, carvings, jewelry, and coins, animals including pets, farm animals, and wildlife, assets such as luggage in airports, pallets, shipping containers, restricted goods, or personnel and equipment in hospitals, airports, construction sites, shopping malls, entertainment venues, public spaces, and finally may be used to track dangerous goods including weapons, explosives, and military equipment.

When operating with herd awareness, sticker 102 may be used to track electronic devices and other items that normally not moved from a home or business, such as herds of farm animals, and wild animals in a localized study group.

Sticker 102 may use variations of the herd concept for security purposes. For example, sticker 102 may be used to collectively group assets into a security network of a home or business. Stickers 102 may also be formed into their own security network, with the advantage of being able to be associated with a trusted circle of employees, family, friends, neighbors, etc. In this manner, for example, one or more users of a family of siblings, parents and their neighbors may get notified if an asset grouped within the herd goes missing. Because the herd (e.g., herd 700 FIG. 7) may be continually searching for new members, with one or more stickers having active receivers, it may also detect and record identify of any electronic wireless instruments, such as a cell phone MEID or 802.11 MAC ID of a tablet that might have been carried or used by anyone during a crime such as theft, burglary or robbery; these recordings may be valuable evidence.

FIG. 8 shows one exemplary scenario 800 where sticker 102 operates in a state awareness mode. When operating in state awareness mode, sticker 102 may stay quiet or transmit an RF beacon signal at a low rate until a change in state is detected. In state awareness mode, sticker 102 may be used to: detect when an asset has moved or has been dropped, detect when an asset changes location, detect when someone is trying to spoof or jam the GPS sensor, detect when itself has become lost from a herd, detect when a person has fallen, become unconscious or has unusual physiological metrics, detect when someone has entered a prohibited area, and detect that it has been removed from the asset. In the example of FIG. 8, sticker 102 detects a state change, increases its rate of transmitting the RF beacon signal, and if a network is in range sends a message 824 to tracking server 170 indicating the state change. Server 170 may then notify a user of the abnormal state of the asset being tracked by sticker 102 by one or more methods configurable on server 170 such as sending an email to any preset email address, sending a text message to a mobile device 802 (FIG. 8) such as a cell phone, activating a local alarm 814, signaling a central alarm station 816 from which a security guard may be dispatched or police notified, activating one or more internet-of-things (IOT) devices 818 such as door locks, air conditioners, furnaces, garage-door openers, fire alarms, or light fixtures, or by other methods known in the security alarm art. In an alternative embodiment, upon detecting particular state changes such as temperatures or humidity beyond limits in the limits table 137 of configuration module 135, sticker 102 checks event-response table 136 (FIG. 2) also in the configuration module 135 and, if configured to do so, also transmits preconfigured commands directly to IOT devices 818, thereby commanding configurable actions such as turning on an air conditioner when a computer, to which sticker 102 is attached, overheats, or shutting off water when an appliance leaks.

Where sticker 102 is installed within a vehicle, it may sense a response to its RF beacon signal and respond with its unique identification, its identification may be used for toll collection, or for automatic paid parking. The sticker may also record the road noise to aid in tracking a vehicle that becomes lost because it would be possible to determine from such recordings the type of road surface, characteristics of traffic and passage by sound sources like railroad crossings, or when the vehicle is in motion. Advantageously, when operating to pay tolls, sticker 102 may record toll booth locations, time of day, and charges paid.

Where sticker 102 is installed in a vehicle, it may listen and record the detection of other vehicles with stickers, or other digital wireless signals it may detect like cellular, Wi-Fi, and Bluetooth radios, including logging any MEIDs detected from cell phones or MAC ID and network names of detected Wi-Fi devices. This type of captured metadata could be used in: law enforcement to determine locations of vehicles with traffic warrants or involved in criminal activities; retrieval of lost or stolen cars including potentially the car with sticker 102; and detection of real-time traffic flow issues and congestion problems. This would be operable even in remote areas or dead zones through the sticker's logging and relaying ability into wider area networks when those networks become available.

Sticker 102 may also extend the coverage of a wireless network and/or change the topology of the network. For example, where multiple stickers 102 each implement Wi-Fi protocol 434 and are present in a smart home, and have sufficient power available, they may extend Wi-Fi connectivity and coverage within a desired area. This could even change network topology based on the inter-sticker communication protocols.

Sticker 102 may also provide connectivity backup. For example, consider where interference interrupts a particular wireless band such that it becomes temporarily unusable. Sticker 102 may translate signals from a first protocol on a first band to a second protocol on a second band to avoid need for long range communications on the unusable band. Thus, sticker 102 may maintain a fully operational network even when certain bands are disrupted or other such outages occur.

Sticker 102 may include a wide variety of sensors 322-348 and multiple stickers 102 may communicate with one another and with a broader network. Thus, sticker 102 may serve as a platform for simultaneous localization and mapping (SLAM). These strategies permit sticker 102 and/or a network of stickers 102 to create an approximate map of their environment and locate one or more stickers 102 within that map.

In an embodiment, and assuming sufficient energy is available to use high-powered radio modes, sticker 102 operates as illustrated in FIG-, 9. The sticker uses SCR 306 to observe 902 network IDs operating in the vicinity of sticker 102, among these network IDs are CID of any local cell tower(s) and any nearby IEEE 802.11 Wi-Fi networks. Sticker 102 then listens for and communicates 904 with any other stickers in the local area. If there is a second sticker in the area, and herd mode is enabled, a hub sticker is determined 906. If sticker 102 is determined to be the hub, and a long-range network such as a cellular telephone network or a Wi-Fi network for which sticker 102 has been configured with a network password exists locally, sticker 102 logs in 910 to that network if not already logged in. This logging-in enables communications between sticker 102 and server 170 over that network.

If acting as a designated hub, sticker 102 relays 912 any reports it receives from other stickers to server 170. Sticker 102 also transmits any environmental change it has observed to the server with a determined location. Once any environmental change has been transmitted to server 170, sticker 102 continues by sensing the local environment 916.

If 908 sticker 102 is not designated huh, sticker 102 transmits any environmental change it has observed as a report to the designated hub sticker and continues sensing the local environment 916. Any audio, strain gauge readings, or accelerometer readings needing processing to classify audio or to determine vibration are processed 920. Then environmental changes are compared 922 to limits in limits table 137 to determine if a reportable change has occurred. If 924 no reportable change has occurred, sticker 102 continues with using the SCR to communicate with any other nearby stickers 904. If 924 a reportable change has occurred, a report is formatted with the reportable environmental change. Sticker 102 continues by determining its current location 926 and appending it to the report, using GPS and if GPS is unavailable using location clues including observed network IDs and other sensor readings. The reportable environmental change is looked up in event-response table 136 to determine whether any commands should be sent to local alarms and IOT devices 818. If commands should be sent to IOT devices 818 or local alarms, those commands are transmitted 928 using the SCR 306 configured for an appropriate protocol before sticker 102 continues with using the SCR to communicate with any other nearby stickers 904.

### Example Specific Embodiments

In an exemplary embodiment for a bicycle, energy harvester 320 of sticker 102 is configured with solar cells or a solar panel to collect solar energy to charge battery 316 and sticker 102 is configured to operate with Wi-Fi protocol, ANT/ANT+ protocol 446, BLE protocol 442, and cellular protocol 428. Sticker 102 is attached to a road bike stored in a garage. Sticker 102 is configured with SSID and encryption keys of the home's Wi-Fi network and may communicate with various user devices (e.g., smartphone, tablet, smartTV, and so on) that are in the home. Because there is a low light level in the garage, harvester 320 generates only enough power for low power, infrequent ANT, BLE or Wi-Fi signals, such that the household network and other smart devices know that it remains present.

On a regular basis however, the road bike is taken out of the garage for an outdoor ride. During these outdoor rides, harvester 320 rapidly charges battery 316. Communication manager 310, during these rides, communicates with the rider's smart phone and forms a small trusted mobile network while away from the home network.

If the road bike is stolen from the garage and sticker 102 is unable to communicate with its home or mobile network, sticker 102 sends a distress signal to any ANT, BLE, Wi-Fi network within its range and for which it has any necessary encryption keys; light levels and battery power permitting, sticker 102 may send a message over a cell-phone network if a cell tower is in range. At the same time, the house network detects that sticker 102 is missing and generates an alert message to server 170, which in turn contacts user and/or enables the large community of stickers to report if sticker 102 is detected.

If awareness module 140 has motion sensors such as accelerometers, and determines it is being stolen before going out of range of its home network, sticker 102 may send a distress signal via the home network to server 170.

In another exemplary embodiment, a herd of outdoor animals is each configured with one sticker 102 that may be attached to an ear, horn, collar, beneath the skin, or in other ways. Each sticker 102 is configured as a transceiver and the stickers 102 cooperate to set up a network and form a herd. Where one animal strays from the herd, sticker 102 determines that it can no longer communicate with any other sticker of the herd and transmits a “distress signal”. This distress signal may he transmitted periodically using one or more protocols 420-452 of sticker 102 but may not be detected until sticker 102 is within the range of a compatible network. At the same time, another sticker 102 of the herd determines that one member of the herd is missing and it also sends an alert to server 170 when in range of a compatible network. Server 170, upon becoming aware of the alert, may then instruct other stickers, which may he in other herds and associated with other types of devices, to report if the missing sticker is detected.

In another exemplary embodiment, a collection of objects such as electronics, paintings, valuables, safes, and sporting equipment in a house, museum, or business (hereinafter building) are each configured with a sticker 102. Each sticker 102 is self-powered as by an energy harvesting device such as solar cells and/or a battery, or powered by mains electricity. Collectively, stickers 102 form a herd and cooperate to track devices that enter and leave the building regularly such as mobile phones, bicycles, and cars, and those objects that normally don't leave the building like paintings and media electronics. When a new object enters the building, its sticker 102 may request to join the herd. For example, a mobile device running functionality of sticker 102 in an app may request to join the herd when entering the building. It may or may not be given permission to join the herd depending on the permissions given by an administrator of the herd and found in configuration module 135. For example, a sticker of a visiting party may not be allowed to join the herd, however, where a new piece of art is brought into the building and a new sticker 102 is placed on the art and activated, when the new sticker 102 requests to join the herd of the building, it is accepted and tracked. Where sticker 102 determines that an associated object leaves the building, sticker 102 signals server 170 which may then contact an owner device to see if it is permitted for the object to leave the building, and/or to notify the owner that the sticker and associated object has gone missing. Where the owner has configured sticker 102 as not having permission to leave the herd, sticker 102 may generate an alert when leaving the building.

### Combinations

The location device may include many different combinations of the features herein described. Among combinations specifically anticipated by the inventors are:

A first location device designated A, including a circuit board having a processor and a memory coupled with the processor; a unique identifier configured in the memory; a communicator configured to communicate through a network to a server and to communicate directly with at least a second location device; and at least one sensor configured. to sense an environment of the location device. The memory includes firmware configured to determine location information of the location device; to determine a change in status as observed by the at least one sensor, and to transmit a message including the unique identifier and the location information to the server upon detecting a change in status.

A first location device designated AA including the features of the first location device designated A, the at least one sensor including a sensor configured to sense movement of the first location device.

A first location device designated AB including the features of the first location device designated A or AA, the communicator including at least one software configurable radio configurable to communicate using a plurality of different protocols and the memory contains firmware adapted to configure the software configurable radio and communicate using at least two of the plurality of different protocols.

A first location device designated AC including the features of the first location device designated A, AA, or AB the communicator configured to communicate with a second location device using a first of the at least two of the plurality of different protocols, and to communicate with the server using a second of the at least two of the plurality of different protocols

A first location device designated AD including the features of the first location device designated A, AA, AB, or AC the first location device configured to relay a message received from the second location device to the server.

A first location device designated AE including the features of the first location device designated A, AA, AB, AC, or AD the first location device configured to send one or both of sensed movement information and motion information to the server via a digital radio network, the communicator including a digital radio configurable for communicating directly with the digital radio network.

A first location device designated AF including the features of the first location device designated A, AA, AB, AC, AD, or AE, the firmware configured to use the software configurable radio to receive radio signals from a local environment to log at least one identifier selected from the group consisting of an IEEE 802.11 network SSID, a MAC addresses, an IP address, and a Cell ID (CID) associated with a nearby cellular telephone base station and to transmit the at least one identifier to the server.

A first location device designated AG including the features of the first location device designated A, AA, AB, AC, AD, or AF wherein the firmware configured to transmit the at least one identifier to the server is configured to transmit the at least one identifier to the server upon detecting movement of the first location device.

A first location device designated AH including the features of the first location device designated AA, AB, AC, AD, or AG the firmware further comprising machine readable instructions that, when executed by the processor, are capable of collaborating with at least the second location device to create a local digital radio network of location devices.

A first location device designated AJ including the features of the first location device designated AH, the firmware configured to determine when the second location device is lost from the local digital radio network of location devices, and the firmware is configured to transmit a message to the server when the second location device is lost from the local digital radio network of location devices.

A first location device designated AK including the features of the first location device designated A, AA, AB, AC, AD, AG, AH, or AJ, the firmware configured to send a preconfigured command to an Internet-of-things (IOT) device upon determining a particular change of status.

A first location device designated AK including the features of the first location device designated A, AA, AB, AC, AD, AG, AH, or AJ, and having an energy harvesting device coupled to power the location device.

A first location device designated AL including the features of the first location device designated A, AA, AB, AC, AD, AG, AH, AJ, or AL, the at least one sensor including a strain sensor.

A first location device designated AM including the features of the first location device designated AC, AD, AG, AH, AJ, AL, or AL, the communicator including machine readable instructions stored within the memory that, when executed by the processor, are capable of operating the first location device as a hub for relaying communications between the second location device and the server.

A method for tracking the location of assets designated B, includes using a first sticker location device configured with the asset to sense an environment of the asset; detecting, within the sticker location device, changes in the environment by comparing the sensed environment to a previously sensed environment; and communicating location information and the changes in the environment from the sticker location device to a server when the changes exceed a configurable threshold.

A method for tracking the location of assets designated BA including the method designated B, the step of sensing the environment including sensing audio with a microphone, and the step of detecting changes in the environment further comprises classifying the audio.

A method for tracking the location of assets designated BB including the method designated B or BA, further comprising communicating changes in an environment sensed by a second sticker location device to the server when the changes in the environment exceed a configurable threshold.

A method for tracking the location of assets designated BC including the method designated B, BA, or BB wherein sensing an environment comprises using a software configurable radio to sniff identifiers associated with digital radio networks.

A sticker location device designated C has a housing; a circuit board within the housing with a memory coupled with a processor; a communicator configured to communicate through a network to a server and to communicate directly with at least a second sticker location device; firmware configured to use a software configurable radio to record network identifiers of digital radio networks received by the software configurable radio; a sensor configured to observe an environment of the first sticker device; and firmware configured to determine a change in the observed environment, and to transmit a message to the server upon detecting a change in status, the message including the recorded network identifiers.

A sticker location device designated D, has a housing; a circuit board within the housing with: a memory coupled with a processor; a communicator controlled by the processor and configured to communicate through a network to a server; at least one sensor configured to sense movement of the sticker device; at least one strain sensor; firmware configured to process readings from the at least one sensor configured to sense movement and the at least one strain sensor to determine vibration and strain, to determine if either sensed vibration or strain exceed limits, and to send a message to the server when either vibration or strain exceed the limits.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween

1. A first location device, comprising:
a circuit board configured with:
a processor;
a memory communicatively coupled with the processor;
a unique identifier configured in the memory;
a communicator configured to communicate through a network to a server and to communicate directly with at least a second location device;
at least one sensor configured to sense an environment of the first location device;
firmware in the memory configured to determine location information of the first location device; and
firmware in the memory configured to determine a change in status as observed by the at least one sensor, and to transmit a message including the unique identifier and the location information to the server upon detecting a change in status.

2. The first location device of claim 1, the at least one sensor comprising at least one sensor configured to sense movement of the first location device.

3. The first location device of claim 2, the communicator comprising at least one software configurable radio configurable to communicate using a plurality of different protocols and the memory contains firmware adapted to configure the software configurable radio and communicate using at least two of the plurality of different protocols.

4. The first location device of claim 3, the communicator configured to communicate with a second location device using a first of the at least two of the plurality of different protocols, and to communicate with the server using a second of the at least two of the plurality of different protocols

5. The first location device of claim 4, the first location device configured to relay a message received from the second location device to the server.

6. The first location device of claim 2, the first location device configured to send one or both of sensed movement and motion information to the server via a digital radio network, the communicator comprising a digital radio configurable for communicating directly with the digital radio network.

7. The first locator device of claim 3 further comprising firmware configured to use the software configurable radio to receive radio signals from a local environment to record at least one identifier selected from the group consisting of an IEEE 802.11 network SSID, a MAC addresses, an IP address, and a Cell ID (CID) associated with a nearby cellular telephone base station; and firmware configured to transmit the at least one identifier to the server.

8. The first locator device of claim 7 wherein the firmware configured to transmit the at least one identifier to the server is configured to transmit the at least one identifier to the server upon detecting movement of the first location device.

9. The first location device of claim 2, the firmware further comprising machine readable instructions that, when executed by the processor, are capable of collaborating with at least the second location device to create a local digital radio network of location devices.

10. The first location device of claim 9, further comprising machine readable instructions capable of determining when the second location device is lost from the local digital radio network of location devices, and the firmware is configured to transmit a message to the server upon the second location device becoming lost from the local digital radio network of location devices.

11. The first sticker location device of claim 1 further comprising firmware adapted to send a preconfigured command to an internet-of-things (IOT) device upon determining a predetermined change of status.

12. The first location device of claim 1 further comprising an energy harvesting device coupled to power the device.

13. The first location device of claim 2, the at least one sensor comprising at least one strain sensor.

14. The location device of claim 4, the firmware comprising machine readable instructions that, when executed by the processor, are capable of operating the location device as a hub for relaying communications between at least the second location device and the server.

15. A method for tracking the location of assets, comprising:
using a first sticker location device configured with the asset to sense an environment of the asset;
detecting, within the sticker location device, changes in the environment by comparing the sensed environment to a previously sensed environment; and
communicating location information and the changes in the environment from the sticker location device to a server when the changes exceed a configurable threshold.

16. The method of claim 15, the step of sensing the environment further comprising sensing audio with a microphone, and the step of detecting changes in the environment further comprises classifying the audio.

17. The method of claim 16 further comprising communicating changes in an environment sensed by a second sticker location device to the server when the changes in the environment exceed a configurable threshold.

18. The method of claim 15, wherein sensing an environment comprises using a software configurable radio to sniff identifiers associated with digital radio networks.

19. A first sticker location device comprising:
a housing;
a circuit board within the housing and configured with:
a processor;
a memory communicatively coupled with the processor;
a communicator configured to communicate through a network to a server and to communicate directly with at least a second sticker location device;
firmware configured to use a software configurable radio to record network identifiers of digital radio networks received by the software configurable radio;
a sensor configured to observe an environment of the first sticker device; and
firmware configured to determine a change in the observed environment, and to transmit a message to the server upon detecting a change in status, the message including the recorded network identifiers.

20. A sticker location device, comprising:
a housing;
a circuit board within the housing and configured with:
a processor;
a memory communicatively coupled with the processor;
a communicator configured to communicate through a network to a server;
at least one sensor configured to sense movement of the sticker device;
at least one strain sensor;
firmware configured to process readings from the at least one sensor configured to sense movement and the at least one strain sensor to determine vibration and strain, to determine if either sensed vibration or strain exceed limits, and to send a message to the server when either vibration or strain exceed the limits.
